(19) United States
(12) Patent Application Publication
(10) Pub. No.: US 2014/0279239 A1
(43) Pub. Date: Sep. 18, 2014

(54) Computer Implemented Search System

(71) Applicant: Kuyam Companies, Inc., Los Angeles, CA (US)

(72) Inventors: Kourosh Gohar, Los Angeles, CA (US); Tony Rhoton, American Fork, UT (US); Todd M. Zebert, Encino, CA (US); Jackie Chang, Los Angeles, CA (US)

(73) Assignee: Kuyam Companies, Inc., Los Angeles, CA (US)

(21) Appl. No.: 14/043,726

(22) Filed: Oct. 1, 2013

Related U.S. Application Data
(63) Continuation-in-part of application No. 13/941,397, filed on Jul. 12, 2013.
Application No. 13/941,397 is a continuation-in-part of application No. 13/872,023, filed on Apr. 26, 2013.
Application No. 13/872,023 is a continuation-in-part of application No. 13/837,413, filed on Mar. 15, 2013.

(51) Int. Cl. G06Q 30/06

(52) U.S. Cl. CPC G06Q 30/0617
USPC 705/26.43

(57) ABSTRACT

An informational and educational blog within a platform that acts as a marketplace for booking appointments for services desired by a user comprising compiling a database of companies available for the user to search, the database comprising a profile about each company, including the category of services, the location of the company and the available appointments for the services, a search platform accessible by a user operating a computer or a mobile device, the platform allowing the user to search by a category of service, name of a company, location, or date and time available for an appointment, the platform comprising a chat option whereby the user can contact a platform agent to arrange available appointments.

This application is a continuation-in-part application of U.S. patent application Ser. No. 13/941,397 filed Jul. 12, 1013; which is a continuation-in-part of U.S. patent application Ser. No. 13/872,023 filed Apr. 26, 2013, which is a continuation-in-part application of U.S. patent application Ser. No. 13/837,413 filed Mar. 15, 2013, all of which applications are incorporated herein by reference, in their entireties.

### FIELD OF THE INVENTION

The invention described herein comprises an informational and educational blog within a platform that acts as a marketplace which empowers its users, the buyers of listed services and its establishments, the sellers of listed services, the capabilities to search, discover, schedule, share and store a user based schedule and blogs.

### BACKGROUND OF THE INVENTION

Technology has provided public and private establishments with many means for consumers to schedule appointments. Consumers can make an appointment with an establishment over the phone or via email. Some establishments even offer consumers an option to schedule appointments online by visiting the establishment's website. While technology has made this process easier, consumers who wish to make appointments with multiple establishments have to make several phone calls, and/or log onto several different websites for each establishment. Furthermore, most establishments still lack the means to allow consumers to make appointments online. These limitations waste valuable time and are mistake prone. There is a need to provide consumers with a single integrated platform, a “one stop shop”, which allows consumers to make, modify or cancel online appointments, all on one platform.

There is also a need for a more effective search system that makes it easier for a user to find and learn about companies and businesses and book appointments with them.

### SUMMARY OF THE INVENTION

The invention described herein has improvements over the systems described in the three parent applications referred to above. One of the improvements is the addition of a blog on the mobile apps and on the web site. The mobile and website home pages will highlight the blog posts and the featured companies all at once. The purpose of the blog feature is to expose useful and educational information to consumers, through the blog posts, thereby providing more value to users and enticing them to return to the site often. In addition, the blog is the foundation of the social/network for the platform through sharing/comment section of the blog. In some cases, it will be relevant for a blog post to mention a certain company which exists in the database which can be any of four types of related companies and can then provide links to directly schedule appointments with a company, or companies.

Another improvement is a voice interaction function to the mobile apps and web that enables a consumer to chat with a kuyam agent and book an appointment simply by using their voice. The consumer could use this feature, hands free, while driving their car, since they do not have to type any messages. This feature functions similarly to using the current kuyam chat feature in which a consumer can chat with kuyam agent. The main difference is that the user/consumer can optionally speak to the app to allow the phone to transcribe the message (using voice-to-text technology) and the phone can speak back the response that the kuyam agent writes (using text-to-voice technology).

The system of this invention, as described in the parent applications, provides means to easily and effectively search using the platform web site or using a mobile phone or smartphone, to find a company for which the user has a need. This can be accomplished using the system search features to search for a specific category, favorite company and/or previously purchased packages. The search can also be made by selecting category icons that represent the services that the companies offer through the platform.

This enables users to find companies and services and book appointments while not having to have an actual phone call. Instead the conversation can be continued over a longer period of time than a typical phone call, and the user can either enable or disable the voice interaction component to suit their current environment, such as in the car, out in public or at work. The user will be able to disable the speech recognition and text-to-speech feature as needed, and continue the conversation by typing.

For example, perhaps the user is driving in their car and uses this feature to start a conversation to locate and book an appointment with a personal trainer, and the agent has to go away for a half hour to do research, then subsequently when the agent comes back online, they can continue the conversation using the same app, but perhaps in quiet mode (voice feature disabled) since the user might be at work in a meeting.

In the mobile app, a new button will be present from the right menu to allow the user to launch the voice interaction feature. This opens the voice chat screen.

The voice chat screen shows both the text messages between the consumer and the agent and has a section to enter messages to respond to the agent manually.

When the voice chat screen comes up, an automated message appears from the agent saying “hello! how can I help you today?”

After the agent message is spoken, the app automatically switches to recording mode.

The user can tap on the microphone button and it will also manually start the recording mode.

Any time the app is “speaking” the response from the agent, the user can interrupt the speech by tapping the microphone icon to start recording their own voice.

After recording has started, if a preset number of seconds have passed where no voice was detected, the recording window closes and the app must transcribe the recording and display the message on screen, and send the message to the agent.

When recording mode turns on, the app plays a beep sound that is unique to the “recording start” action.

When the recording mode turns off and transcription starts, the app plays a beep sound that is unique to the “recording end” action.

There is an “audio” button on the voice chat screen to enable/disable the voice/sound feature. By default this is enabled. If enabled, both the voice-to-text and text-to-speech functions will operate. If disabled, the app is silent, no recording may occur, and the user can only interact using the text input field.

If the audio button is disabled, and the user taps the microphone icon, audio is enabled and the app starts recording voice immediately.

The agent can use a chat platform or another interface to chat with the client.

The agent is notified of new chat sessions and new chat messages within an existing session so that the agent is able to respond very quickly to the consumer.

If the consumer stops using the voice chat screen by going back to the previous screen, or by using another app completely, the user is notified of any new chat messages received from the agent. A notification will appear at the top of the screen, and then, if the user taps that notification, they would be taken straight into the voice chat screen.

The kuyam agent may be chatting with several consumers at the same time and the agent is notified of new messages within each chat session, and they are able to navigate between active chat sessions. The purpose is to support the scenario where an agent may have to go away for 15 or 30 minutes to research appointment options for the user, and then return to complete the transaction.

An agent can also book an appointment on behalf of the client, so that the entire booking process could occur without the user calling the service provider. The agent can push an appointment summary to the user by sending a link, or the next time the user logs into the web site or opens the app, the user can review and confirm the appointment.

The consumer must be able to launch this chat screen from the menu, using one of two buttons. One button launches the chat screen with voice enabled, and the other launches the chat screen with voice disabled. Either way, the user can enable/disable the voice feature subsequently.

### BRIEF DESCRIPTION OF THE DRAWINGS

FIG. 1 is a diagram illustrating the step by step operation of the chat feature;

FIG. 2A shows a mobile device search page for certain company profiles;

FIG. 2B shows a mobile device in voice chat with an agent;

FIG. 2C shows a mobile device chat menu;

FIG. 3 is a diagram illustrating the step by step operation of the blog feature;

FIG. 4A shows a mobile device blog main page;

FIG. 4B shows a mobile device blog article;

FIG. 4C shows a mobile device blog sharing an article;

FIG. 4D shows a mobile device blog comments;

FIG. 5 is a diagram, illustrating the step by step web blog;

FIG. 6 shows a web blog—mail page after log in; and,

FIG. 7 shows a web blog article after log in.

### DETAILED DESCRIPTION

Referring to the drawings, FIG. 1 shows the steps taken to utilize the system of the invention. Step 1 the user logs into the kuyam system. Step 2 the user selects a company to book an appointment at the company profile page. Step 3 the user selects a type 4 company (as described in detail in the parent application, included herein by reference and set forth below). Step 4 the user taps the “chat to book” button which takes the user to Step 11 where the user enters chat with a kuyam agent.

The platform lists service provider company availabilities in four different types:

Company type 1—kuyam instant-book; this is a company that lists its hours on the platform. The user searches a service provider company's available hours and books one from the list of available time slots. The appointment is booked instantly and notices are sent to both the user and the service provider.
Company type 2—kuyam book-it; some of the companies signed up on kuyam's platform do not offer instant booking but offer a deferred process where the user requests a listed timeslot, a kuyam agent (platform agent) reaches out to the company to confirm the availability of the timeslot, and once confirmed, or modified, the booking is passed on to the user;
Company type 3—hybrid-kuyam; for companies that are not kuyam clients but list their availabilities online. This service is offered to kuyam users to provide them with more selections and options even though kuyam may not get compensated for the booking of the appointment;
Company type 4—non-kuyam; this is for companies that are not kuyam clients, do not offer or list their available services online, and do not list much information about the specifics of their services. Kuyam agents chat both with the user and the service provider, back and forth, until a mutually acceptable appointment is scheduled.

Regardless of whether the company is a kuyam instant book; kuyam book-it; hybrid-kuyam; or non-kuyam, a chat option is also available to the user. With the chat option, the user can bypass the process of looking for an appointment themselves and can start chatting directly with a kuyam agent.

Alternatively, Step 5 the user selects a company type 1, 2, or 3; instant book, book it or hybrid (again the company types are described in detail in the parent application, included herein by reference and also set forth above). Step 6 the user browses the available times and Step 7, if the user does not see a desired time, the user taps “can't find a time? let's chat” button and is taken to Step 11 and enters chat with a kuyam agent.

Alternatively, Step 8 the user taps the chat button 105 on the top right of the mobile device (see FIG. 2A) which opens the right menu (see FIG. 2C). Step 9 the chat menu appears on the mobile device (see FIG. 2C).

The user has three alternatives. One, Step 10 the user taps on the keyboard 178, FIG. 2C and Step 11, the user enters the chat with a kuyam agent. The user can then, Step 12, type a message in the text box 148 FIG. 2B and send it to an agent. Or Step 14 the user can tap the mute button 173, FIG. 2B, a toggle mute/umnute for the chat agent. If muted, the user can type into the chat message box for the user to send. Step 13 the user can hold down the mic button 177, FIG. 2C, and enter a voice chat with the agent.

The second alternative, Step 15 the user holds down the mic button 177 and Step 16 the voice is recorded and the message is automatically sent to the agent. From Step 12 or Step 16 Step 19 the agent finds out the preferred day, time and service and books the appointment.

The third alternative, Step 17 under notes the user chooses chat with a company 180 FIG. 2C, the user Step 18 enters chat with the selected company by text and then to Step 13 or 12 to use a voice chat or a typed message and Step 19 the agent books the appointment.

Referring to FIG. 2A there is seen the company profile page where there is a company profile 100. On the left is menu 102. There is a search tab 103, a favorites tab 104 and a live chat button 105. There is also a company name 106 and a heart 107 to put that company into the favorites list. There is also a series of stars 108 that shows the rating of the company.

There is an information button about the company 110, a description of the company button 112 and reviews of the company 114, packages if offered by the company, as well as the business hours 116, the phone number 118 and the directions 120. There is also a chat to book tab 142.

Referring to FIG. 2B there is shown the mobile device set up to voice chat with an agent. There is a back button 146, the company name at the top 145 and the initial contact from the agent 144 where the agent states, “hello! how can we help?”. There is an audio button 173 a microphone button 174 a “type message here” area 148 and a send button 150.

Referring to FIG. 2C there is shown the Mobile Chat Menu on the mobile device. It shows a chat button 105 a live chat 175 and feedback 176. There is the microphone 177 the choice to use the keyboard 178 and a chat history 179. If the user clicks on mic 177, it takes the user to 2B. Notes 180 represent discussions between the user and the service provider.

Referring to FIG. 3, there is shown the mobile blog feature of the system. Step 1 the user logs onto the kuyam search and appointment system. This takes the user Step 2 to the mobile device blog main page (see FIG. 4A). The user has alternatives. The user can tap on an article Step 3, tap on bookmarks, Step 10, tap on categories Step 15, tap on a featured company Step 23, tap on search Step 29 or tap on favorites Step 31.

From Step 3 the user goes to the selected article Step 4 which is displayed. The user can bookmark the article Step 5 and the article is saved in “bookmarks” Step 6. The user can tap the bookmark button Step 7 to remove the bookmark. From Step 4 the user can tap on the author's name Step 8 and all articles by the author are listed Step 9.

The user can tap on bookmarks Step 10. Step 11 a list of previously bookmarked articles is shown. Step 12 a selected article from the list will be displayed Step 4. The user can share the article Step 13 and the article is shared via text, social media platforms or email, Step 14.

From Step 15, the user has tapped on categories. Step 16 categories of blog articles are listed. The user chooses Step 17 a category. Step 18 articles under the category are listed. The 200 user selects an article Step 19. The selected article is displayed Step 4. The user can tap Step 20 “view comments”. The user can reply to a comment Step 22 and the user can comment on the article Step 21

From Step 23 where the user taps on a featured company, the user will go to the company profile Step 24. The user can Step 25 book an appointment with the company.

From Step 29 where the user tapped on a search, the user searches for a company Step 30 the user will select a company Step 32 and will be sent to the company profile Step 24 where the user can book an appointment Step 25.

From Step 31 where the user taps on favorites, the user selects a company Step 32 and receives the company profile Step 24 and can book an appointment Step 25.

From Step 4, the user can tap Step 28 on a company name written in the article, the user can then go to Step 24 the company profile and the user can book an appointment with the company through kuyam Step 25.

As an extra feature, where articles or blogs are displayed Step 4, the user can tap “settings” Step 26 and the user can Step 27 toggle the font, size or background color display. The blog can be in text or video or a combination thereof.

Referring now to FIG. 4A, there is shown a mobile device blog main page. There is a left menu 102, a search button 103, a favorites button 104 and a chat button 105 right menu. A blog article title 182 is displayed. Two images are displayed 181 is a photo of a blog post and 100 is a photo of a featured company. By scrolling up or down more blogs or featured companies will be shown. There is a categories button 183 and a bookmark button 184.

FIG. 4B shows a mobile blog article page. There is the blog article title 182 with the author's name 188. There is a back button 189 and an image displayed of the article 181. Added to the categories 183 and bookmarks 184 are a settings button 185 to adjust fonts size and color and background and there is a share button 186.

Referring to FIG. 4C, a mobile blog—share an article. There is shown the Blog Article Title 182 with the author's name 188. There is an image displayed 181 of the article. Catagories 183, bookmarks 184, settings 185 and share 186 are at the bottom of the screen. Just above the just mentioned list are methods of sharing, namely, text or SMS 194, Facebook 193, Twitter 192, Goggle Plus 191, and email 190. The text of the blog post is at 195. The blog can be bookmarked by tapping 187. Tapping 187 a second time removes the bookmark.

Referring to FIG. 4D, mobile blog—comments, there is shown the face of the mobile device which has “post a comment” 199 to preview a comment. There is an existing comment at 196 and a respond to a comment 198 each of which sets forth the user date and time of the comment. 197 is a photo of the user of the mobile device

Referring to FIG. 5 there is shown a web blog—main page with a step-by-step use of the web blog. First step the user can see articles, featured companies and press coverage. Step 2 the user logs into the kuyam system, where the user Step 3 goes to the kuyam blog main page or goes to left side menu. From the kuyam blog main page the user can go to Step 9 and click on an article or the user can go to Step 11 and clicks on a blog category. The user may also go to Step 14 where the user clicks on a featured company.

From Step 9 the user can go to Step 10 where the selected article is displayed. The user can then go to Step 15 where the user clicks on an author's name where Step 16 all articles by the author are listed. From Step 11 where the user clicks on a blog category, articles Step 12 under the category are listed and Step 13 the user selects an article and the selected article is displayed in Step 10.

From Step 10 the user can reply to a comment Step 28, the user can share the article Step 29 and the article can be shared via social media platforms or email Step 30. In addition, the user can comment on the article Step 31. Also the user can click on a non-profit article Step 32 and has the option to donate funds to the non-profit Step 35 or the user can see available time slots for volunteering are listed Step 33 and the user can schedule a time-slot to volunteer Step 34.

The user can also Step 27 scroll down and tap on another article under “also on our blog” or the user can click on a company name written in the article or the book it button Step 22.

Where the user clicks on a featured company Step 14, the user goes to the company profile Step 20 or the user can go to Step 20 from Step 22 and from Step 21 the user can book an appointment with the company.

Where the user selects a category in the drop-down menu Step 17 the user can go to Step 18 to find search results based on the company name or category, where the user selects a company Step 19 goes to the company profile Step 20 and books an appointment with the company Step 21.

From the left menu on the web site Step 4 the user can select “appointments” Step 5 and appointment status updates are listed. Or the user can select “calendar” Step 7 and the user's calendar Step 8 is displayed. The user can also select Step 23 under schedule user searches for a company by name or category and reaches Step 18 for the search results and proceeds to Steps 19, 20, and 21 as referred to above.

The user can also Step 24 click on a favorite, select a company Step 19 and go on to Steps 20, and 21. Finally the user can go to Step 25 where the user clicks on “select a package” and Step 26 the user chooses a purchased package and goes directly to Step 21 and books an appointment.

Referring to FIG. 6, there is shown a web page—main after log in. The screen comprises at the top, the kuyam name 202, select a category 201, live chat support 204, the user name 205 and sign out 206. On the left side is “our blog” 203, the schedule button 210 to initiate a new appointment, find a company 211, select a favorite 212 and select a package 213. Also on the left is the status of booked appointments 214 and a calendar 215. A variety of categories 207, and by clicking on a desired category, blogs in that category will be shown.

A large blog article title is shown 209 with an image displayed 208. There are a plurality of blog article titles with image displays available for the user to choose, such as 218 and 219. There are also a plurality of featured companies with image displays such as 216 and 217.

Referring to FIG. 7 there is shown the screen web blog—article after log in. The screen comprises at the top, the kuyam name 202, select a category 201, live chat support 204, the user name 205 and sign out 206. On the left side menu is “our blog” 203, the user's schedule 210, find a company 211, select a favorite 212 and select a package 213. Also on the left is appointments 214 and a calendar 215. Below the top strip there are the categories 207.

A Blog Article Title 219 with the author's name 220 is at the top portion of the screen, a box within the article field has the following: view comments 224, Facebook 223, Twitter 239, Goggle Plus 222, email 221. There is an image displayed 225 and an image caption 226.

There is a plurality of blog article titles 228 with images displayed 227. There is an ad displayed 229. There is an area to post a comment 230 a preview comment 232 and post the comment 231. There are comments with a user image 233 and user date and time posted 236 with an area for a reply to a comment 237. There is also a company name and image displayed 235 and 234. There is a tags category 238.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What we claim is:

1. A computer implemented method of booking an appointment for services desired by a user comprising:
compiling a database of service companies available for the user to search;
the database comprising a profile about each company;
the profile comprising one or more of, the company's category of services provided; the location of the company and the available appointment days and times for providing the services;
providing a platform operable by a computer processor accessible by a user operating a computer or a mobile device;
the platform comprising a chat option whereby the user can contact a platform agent;
the user activating the chat option to contact a platform agent who will arrange an available appointment with the service company and advise the user of the confirmed appointment.

2. The method of booking an appointment for services of claim 1 in which the mobile device has a microphone which the user can hold down in order to voice talk to an agent.

3. The method of booking an appointment for services of claim 1 in which the mobile device has a mute/unmute toggle button allowing the user to switch between voice communication or voice record to text communication.

4. The method of booking an appointment for services of claim 1 in which the mobile device has a keyboard and communication with an agent is done by text.

5. The method of booking an appointment for services of claim 1 in which the mobile device and the computer comprise a blog.

6. The method of booking an appointment for services of claim 5 in which a blog article appears on the main page upon login.

7. The method of booking an appointment for services of claim 6 in which the user can choose by tapping on one of, the blog article, on bookmarks, on categories, on a featured company, on search or on favorites.

8. The method of booking an appointment for services of claim 7 in which the user can bookmark the blog article and the article is saved in bookmarks.

9. The method of booking an appointment for services of claim 1 in which the user can share the blog article via text, social media platforms or email.

10. A computer implemented method of booking services desired by a user comprising:
compiling a database of service companies available for the user to search;
the database comprising a profile about each company;
the profile comprising one or more of, the company's category of services provided and the location of the company;
providing a platform operable by a computer processor accessible by a user operating a computer or a mobile device;
the platform comprising a blog in which a blog article appears on the main page upon login.

11. The computer implemented method of booking services desired by a user of claim 10 in which the user can choose by tapping on one of, the blog article, on bookmarks, on categories, on a featured company, on search or on favorites.

12. The computer implemented method of booking services desired by a user of claim 10 in which a plurality of blog article titles appear on the main page upon log in.

13. The computer implemented method of booking services desired by a user of claim 10 in which a plurality of blog articles titles and a plurality of featured company information appear on the main page upon log in.

14. The computer implemented method of booking services desired by a user of claim 10 in which a plurality of blog articles titles and a plurality of featured company information appear on the main page upon log in and the user can post comments about the articles and companies.

15. The computer implemented method of booking services desired by a user of claim 13 the user can share the articles and company information.

16. The computer implemented method of booking services desired by a user of claim 10 in which the user can actuate a chat option whereby the user can contact a platform agent.

17. The method of booking an appointment for services of claim 16 in which the mobile device has a microphone which the user can hold down in order to voice talk to an agent.

18. The method of booking an appointment for services of claim 16 in which the mobile device has a mute/unmute toggle button allowing the user to switch between voice communication or voice record to text communication.
